(19) United States
(12) Patent Application Publication
(10) Pub. No.: US 2012/0265932 A1
(43) Pub. Date: Oct. 18, 2012

(54) METHOD TO INCREASE THE FLEXIBILITY OF CONFIGURATION AND/OR I/O PERFORMANCE ON A DRIVE ARRAY BY CREATION OF RAID VOLUME IN A HETEROGENEOUS MODE

(76) Inventors: Mahmoud K. Jibbe, Wichita, KS (US); Chandan A. Marathe, Lalitha Srinivasa Nilaya (IN); Manjunath Balagatte Gangadharan, Bangalore (IN); Natesh Somanna, Bangalore (IN)

(21) Appl. No.: 13/085,713

(22) Filed: Apr. 13, 2011

(51) Int. Cl. G06F 12/16

(52) U.S. Cl. 711/114; 711/E12.103

(57) ABSTRACT

An apparatus comprising a controller and a plurality of storage drives. The controller may be configured to generate a control signal in response to one or more input/output requests. The plurality of storage drives may be arranged as one or more volumes. Each of the volumes may comprise a plurality of drive groups. Each of the drive groups may comprise a particular type of storage drive. The controller may be configured to form the volume across drives from two or more of the groups.

### FIELD OF THE INVENTION

The present invention relates to data storage generally and, more particularly, to a method and/or apparatus to increase the flexibility of configuration and/or I/O performance on an array by creation of a RAID volume in a heterogeneous mode.

### BACKGROUND OF THE INVENTION

Conventional approaches often create Redundant Array of Independent Disks (RAID) volume groups with one type of (i) Fibre Channel drive (FC) and Serial Advanced Technology Attachment (SATA) drive, (ii) Serial Attached SCSI (SAS) drives (iii) FC drives, or (iv) SATA drive. Conventional approaches are not able to create RAID volume groups with combinations of (i) FC and SAS drives, (ii) FC, SAS, and SATA drives or (iii) SAS and SATA drives.

In conventional approaches, the drive configuration will have unassigned drives. The unassigned drives cannot be a part of a RAID volume group with another type of drive. If there are only two FC drives and two SAS drives, and a customer wants to create a RAID 3 volume group, the customer cannot create the RAID 3 volume group since there is not another FC drive or SAS drive. Conventional approaches do not help in reducing external fragmentation. Unused storage is often available, but the customer cannot make use of the space.

Conventional approaches provide support for FC, SAS and SATA backend hard drives with a single FC interface. However, conventional approaches do not provide the support for RAID Volume creation using the mixture of FC, SAS and SATA drives. A drive channel with an FC interface supports FC, SATA and SAS drives. FC to SAS interposers can convert the FC interface to the SAS interface, allowing the SAS Drive enclosure to be plugged into the array having the FC interface. However, these examples do not support logical unit number (LUN) creation by mixing FC, SATA and SAS drives.

It would be desirable to implement a method and/or apparatus to increase the flexibility of configuration and I/O performance on a drive array by implementing a volume (e.g., a RAID volume) in a heterogeneous mode. It would also be desirable to support a hybrid mix of drives to create a RAID volume.

### SUMMARY OF THE INVENTION

The present invention concerns an apparatus comprising a controller and a plurality of storage drives. The controller may be configured to generate a control signal in response to one or more input/output requests. The plurality of storage drives may be arranged as one or more volumes. Each of the volumes may comprise a plurality of drive groups. Each of the drive groups may comprise a particular type of storage drive. The controller may be configured to form the volume across drives from two or more of the groups.

The objects, features and advantages of the present invention include providing a method and/or apparatus to increase the flexibility of configuration and I/O performance on an array that may (i) create a RAID volume in a heterogeneous mode (ii) implement different drive types for large storage pool creation, (iii) implement RAID Volume creation based on a performance factor (e.g., I/O is prioritized), (iv) provide efficient utilization of storage space, (v) reduce external fragmentation, (vi) reduce the number of unassigned drives not usable in the RAID volume group, (vii) effectively implement the backend RAID volume based on the importance and/or the type of data, (viii) implement intelligence in RAID firmware, (ix) implement different drives in a hybrid mixture of RAID volumes based on the priority of the data and the type of applications, (x) implement backend FC drives for applications requiring high availability of resources, (xi) implement backend SAS Drives when the majority of the applications access data, (xii) implement SATA drives for less frequently accessed data, lower available resources, and/or data backups and/or (xiii) be implemented cost effectively.

### BRIEF DESCRIPTION OF THE DRAWINGS

These and other objects, features and advantages of the present invention will be apparent from the following detailed description and the appended claims and drawings in which:

FIG. 1 is a block diagram illustrating a context of the present invention;

FIG. 2 is a diagram illustrating the distribution of data types;

FIG. 3 is a diagram illustrating a RAID 1 using the present invention;

FIG. 4 is a diagram illustrating a RAID 3 using the present invention;

FIG. 5 is a diagram illustrating a RAID 01 using the present invention;

FIG. 6 is a diagram illustrating a RAID 10 using the present invention;

FIG. 7 is a diagram illustrating a RAID 30 using the present invention; and

FIG. 8 is a flow diagram of the present invention.

### DETAILED DESCRIPTION OF THE PREFERRED EMBODIMENTS

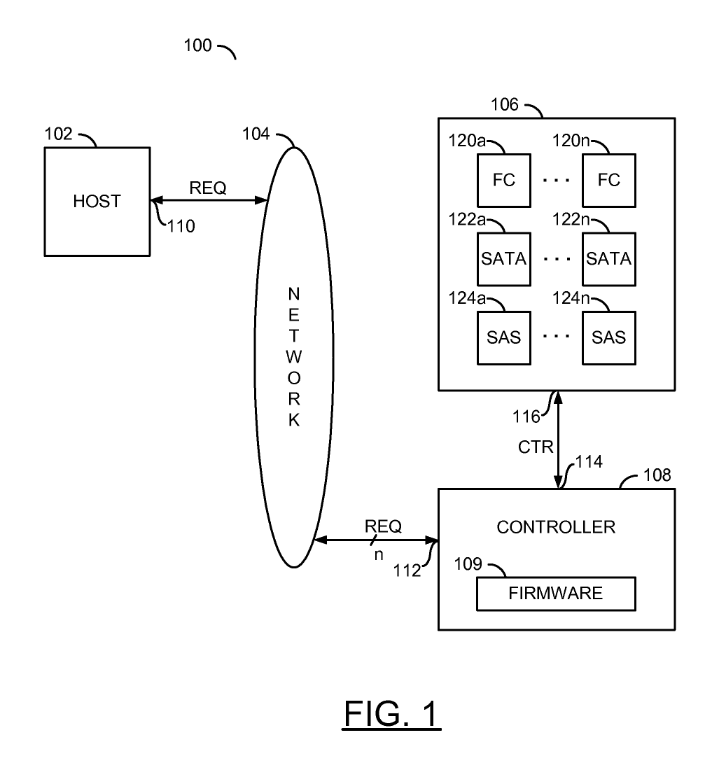

Referring to FIG. 1, a block diagram of a system 100 is shown illustrating a context of the present invention. The system 100 generally comprises a block (or circuit) 102, a network 104, a block (or circuit) 106 and a block (or circuit) 108. The circuit 102 may be implemented as a host. The host 102 may be implemented as one or more computers in a host/client configuration. The circuit 106 may be implemented as a number of storage devices (e.g., a drive array). The circuit 108 may be implemented as a controller. In one example, the circuit 108 may be a RAID controller. The circuit 108 may include a block (or module, or circuit) 109. The block 109 may be implemented as firmware that may control the controller 108.

The host 102 may have an input/output 110 that may present a input/output request (e.g., REQ). The signal REQ may be sent through the network 104 to an input/output 112 of the controller 108. The controller 108 may have an input/output 114 that may present a signal (e.g., CTR) to an input/output 116 of the storage array 106.

The storage array 106 may have a number of storage devices (e.g., drives or volumes) 120a-120n, a number of storage devices (e.g., drives or volumes) 122a-122n and a number of storage devices (e.g., drives or volumes) 124a-124n. In one example, each of the storage devices 120a-120n, 122a-122n, and 124a-124n may be implemented as a single drive, multiple drives, and/or one or more drive enclosures. The storage devices 120a-120n, 122a-122n and/or 124a-124n may be implemented as one or more hard disc drives (HDDs), one or more solid state devices (SSDs) or a combination of HDDs and SSDs. In one example, the storage devices 120a-120n may be implemented as Fibre Channel (FC) drives. In one example, the storage devices 122a-122n may be implemented as Serial Advanced Technology Attachment (SATA) drives. In one example, the storage devices 124a-124n may be implemented as Serial Attached SCSI (SAS) drives. The system 100 may comprise a heterogeneous matrix of drives.

Since the SAS protocol frame is similar to the FC protocol frame, the distribution of input/output (I/O) packets may be transferred between the SAS and FC drives. I/O packets may comprise a destination address. If the data is written onto the FC drive, then the data may be written and/or read according to the supported FC drive speed. Data may be written similarly onto the SAS drive. Redundancy may be provided if the data is striped across the FC and SAS drives, or FC and SATA drives, such as in RAID 0, RAID 50, RAID 60, RAID 30, RAID 10 and/or RAID 01 volume groups.

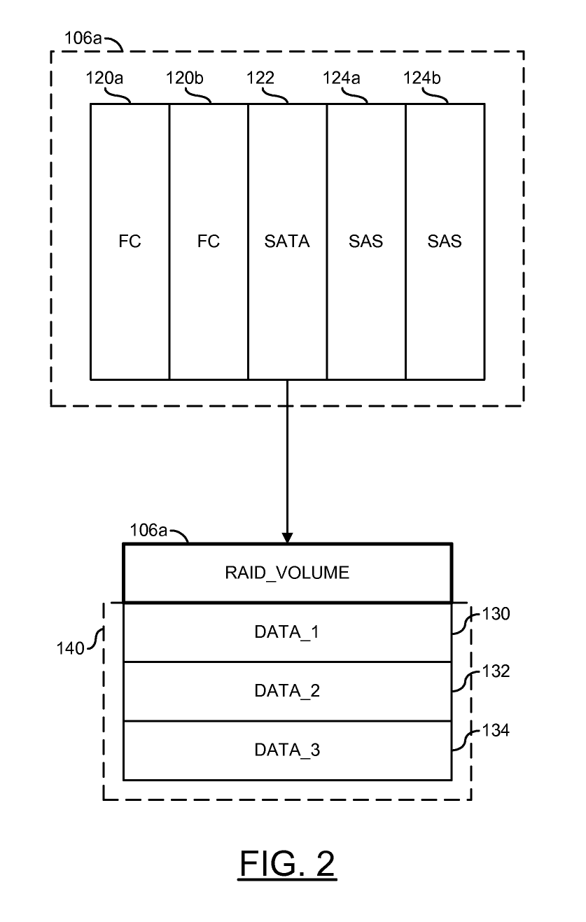

Referring to FIG. 2, a block diagram depicting the RAID volume and/or the distribution of data types across the drives of the circuit 106 is shown. In one example, the RAID volume 106a may comprise five drives (e.g., the drives 120a-120b, 122 and 124a-124b). Two of the drives may be FC drives (e.g., the drives 120a-120b), two other drives may be SAS drives (e.g., drives 124a-124b), and the remaining drive may be a SATA drive (e.g., the drive 122). The volume 106a may include a block 130, a block 132 and a block 134. The block 130, 132 or 134 may be located in a drive enclosure 140. A first data block (e.g., DATA_1 block 130) may comprise frequently accessed data. The first data block may be stored in the backend FC drives. A second data block (e.g., DATA_2 block 132) may comprise data utilized by the majority of the applications. The second data block 132 may be stored in the backend SAS drive. A third data block (e.g., DATA_3 block 134) may comprise less frequently accessed data. The third data block 134 may be stored in the backend SATA drives (e.g., the parity and the backup data).

The drive enclosure 140 may support multiple drive types. In one example, the drive enclosure 140 may implement an FC interface supporting FC, SATA and/or SAS hard drives. The controller 108 may store mapping information. The mapping information may be stored as meta data in a table, as shown in TABLE 1. The table may be implemented in the firmware 109. The logical mapping of the RAID volume 106 may point to the physical mapping of the backend SAS, FC, and/or SATA hard drives 120a-120n, 122a-122n and/or 124a-124n. The logical mapping may be implemented in the controller firmware 109. The firmware 109 may also process routing of the data into the backend SAS, FC, and/or SATA drives. The following TABLE 1 illustrates an example of such mapping:

TABLE 1

| | | Logical | | | |
|---|---|---|---|---|---|
| RAID | | Sector | | Tray ID, | Physical |
| Volume | Data part | range | Drive Type | Slot | Sector range |
| 1 | Data Part 1 | A-D | FC | T₁, S₁ | H-L |
| | Data Part 2 | E-I | SAS | T₂, S₂ | A-D |
| | Data Part 3 | J-O | SATA | T₃, S₃ | P-V |

The firmware 109 may include software code configured to collect additional information in the form of meta data. The firmware 109 may contain the mapping table shown in TABLE 1. The mapping table may comprise the RAID volume and associated drives, tray ID, slot number, the logical sector range and physical sector range, etc. The firmware 109 may also implement functions to control the RAID controller 108. The firmware 109 may categorize the data and/or move the data to the corresponding hard drives 120a-120n, 122a-122n, and/or 124a-124n in a particular RAID volume or RAID volume group 106.

One layer in the controller firmware 109 may manage all the activities of writing the data to the respective backend disks based on the type of data. The volume group 106 may be created with a hybrid mixture of drives. An intelligence layer in the firmware 109 may determine the writing speed to the volume 106 based on the speeds of different interfaces. The volume group 106 may be implemented independently of concerns of the particular type of drive(s) available. The firmware 109 may determine how the data is to be written on the backend disks.

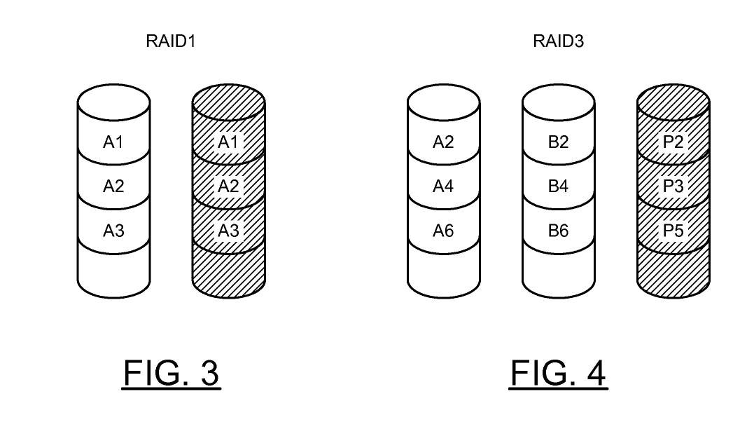

Referring to FIG. 3, a block diagram illustrating a RAID1 is shown. The grey colored (or shaded) drive indicates a SATA hard drive. The colorless drive indicates an FC hard drive. The two sides of the mirror (or volume) in the RAID1 are shown with different types of drives. For example, one side is shown with SATA drives and one is shown with FC drives. The RAID1 volume therefore comprises at least two types of drives. While FC and SATA drives are shown, the particular types of drives implemented may be varied to meet the design criteria of a particular implementation.

Referring to FIG. 4, a block diagram illustrating a RAID3 is shown. Similar to the RAID 1 in FIG. 3, the RAID3 volume shows at least two types of drives. While FC and SATA drives are shown, the particular types of drives implemented may be varied to meet the design criteria of a particular implementation.

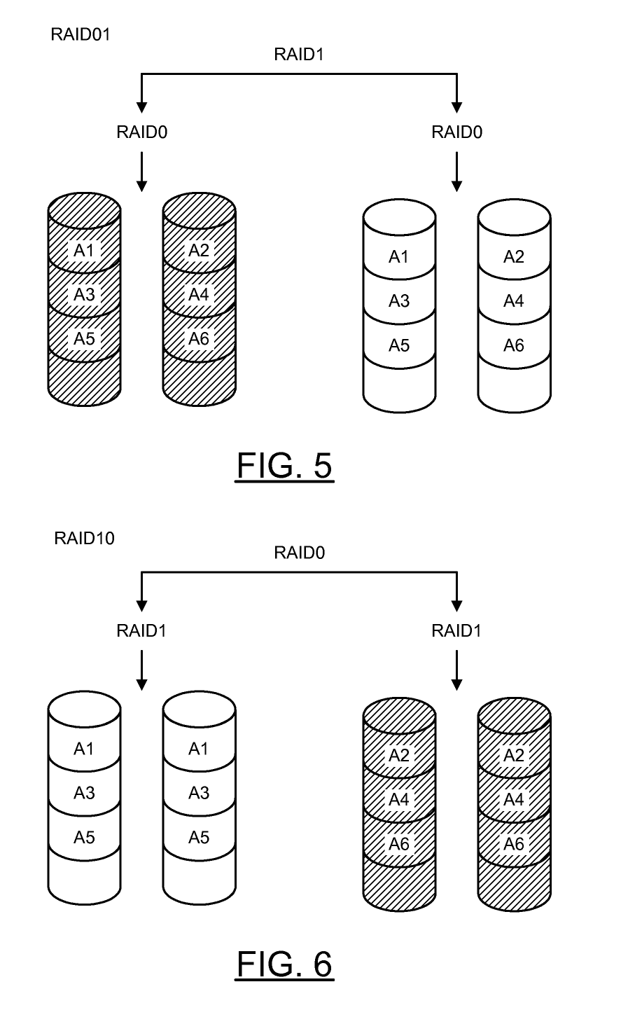

Referring to FIG. 5, a block diagram illustrating a RAID01 is shown. In one example, the RAID01 may comprise two FC and two SATA drives. However, the types of drives may be varied to meet the design criteria of a particular implementation. The data may be written onto the backend FC drives. The mirrored pair of data may be written onto the SATA drives. The I/O may be processed and/or prioritized before mirroring the data. Since FC drives have faster speeds compared to SATA drives, the performance of the data read and/or written may be increased. I/O processing and/or prioritizing may be implemented into the RAID firmware 109. The I/O processing and/or prioritizing may also be altered by a user to meet the design criteria of a particular implementation. The data may be moved to the backend FC drive if the data is frequently utilized.

The RAID01 illustrates an example where portions within each individual RAID0 are implemented with mixed drive types. For example, the data A1, A2, A3, A4, A5 and A6 of the left RAID0 are shown as being shaded, generally indicating data stored on a SATA hard drive. On the right RAID0, the data A1, A2, A3, A4, A5 and A6 are shown not shaded, which generally indicates data stored on an FC hard drive. The particular drives that are implemented as data being either shaded or not shaded may be varied to meet the design criteria of a particular implementation. While FC drives and SATA drives have been illustrated, various combinations other types of drives may be implemented to met the design criteria of a particular implementation.

Referring to FIG. 6, a block diagram illustrating a RAID10 is shown. Similar to the RAID 1 in FIG. 3, the RAID10 volume shows at least two types of drives. While FC and SATA drives are shown, the particular types of drives implemented may be varied to meet the design criteria of a particular implementation. The data A1, A3 and A5 in the left RAID is shown as being not shaded. The data A2, A4 and A6 in the right RAID1 is shown as being shaded. The example shown, unshaded data A1, A3 and A5 represent data stored in one drive type, while the shaded data A2, A4 and A6 represent data being stored in a different drive type. The shaded portions of data (e.g., A2, A4 and A6) generally indicate data stored on a SATA hard drive. The unshaded portions of data (e.g., A1, A3 and A5) generally indicate data stored on an FC drive. However, the particular drives implemented (e.g., represented as either shaded or not shaded) may be varied to meet the design criteria of a particular implementation. Additionally, while FC drives and SATA drives have been illustrated, various combinations of other types of drives may be implemented.

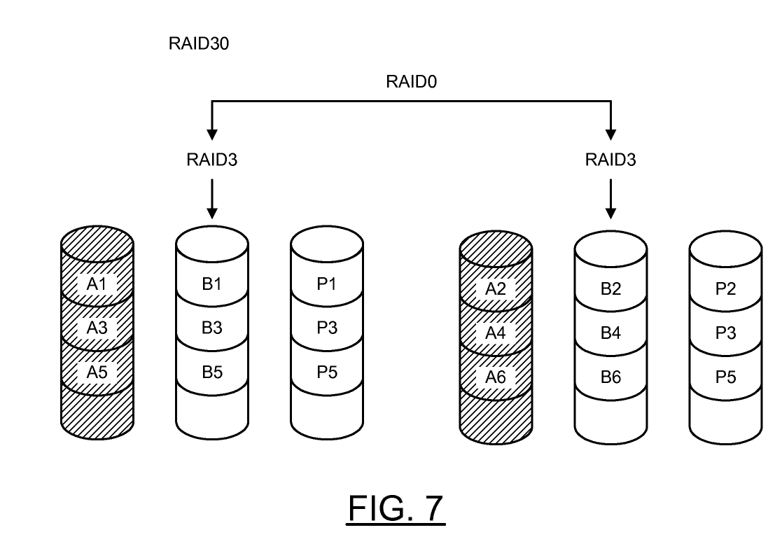

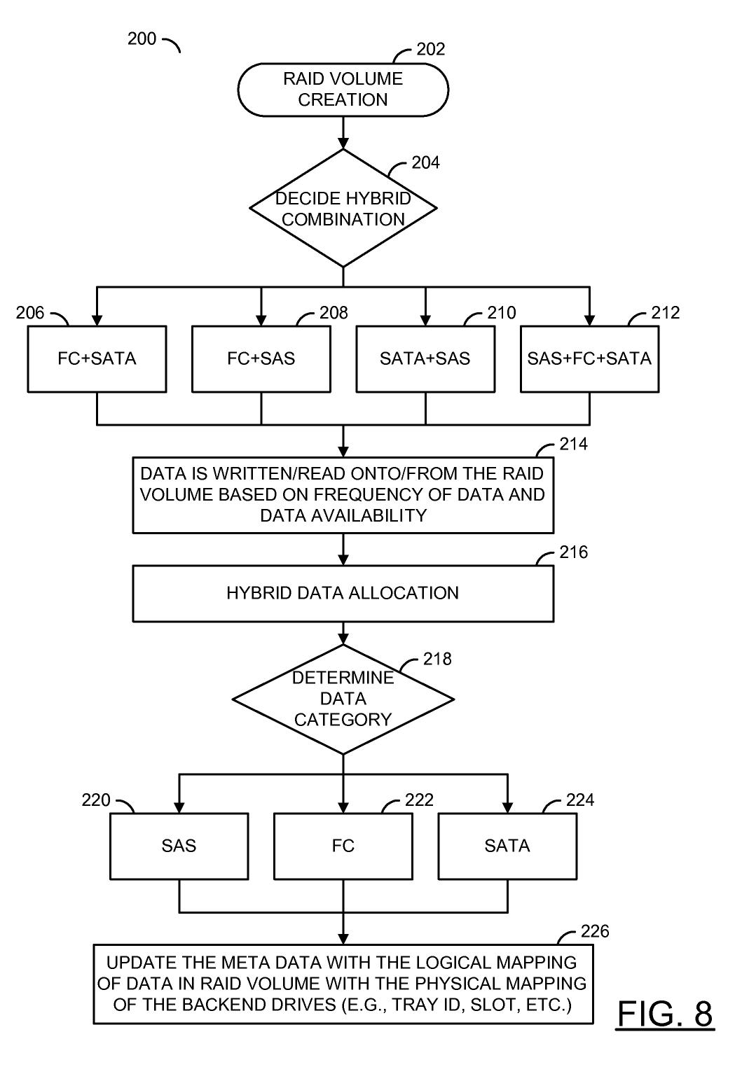

Referring to FIG. 7, a block diagram illustrating a RAID 30 is shown. To process data I/O as quickly as possible, the data I/O may be written onto the FC disks. The mirroring and/or parity data may be implemented on the SAS or SATA drives. The I/O performance may be increased by prioritizing the type of data being written onto the backend drives. The left hand RAID3 shows the data A1, A3 and A5 as being stored on a first drive type. The data B1, B3 and B5 are shown as data stored on a second drive type. The parity data P1, P3 and P5 is shown as data stored on the second drive type. In the right hand RAID3, the data A2, A4 and Ab is shown as data stored on one drive type. The data B2, B4 and B6 is shown as data stored on another drive type. The parity data P2, P3 and P5 is shown as being stored on the same drive type as the data B2, B4 and B6. Various combinations of drive types may be implemented throughout the RAID volumes. The shaded drives generally indicate a SATA hard drive. The unshaded drives generally indicate an FC drive. However, the particular drives that are implemented as either shaded or not shaded may be varied to meet the design criteria of a particular implementation. Additionally, while FC drives and SATA drives have been illustrated, various combinations of any type of drive may be implemented.

The storage devices 120a-120n, 122a-122n and/or 124a-124n (e.g., as shown in FIGS. 3-7) may implement data backup, mirroring and/or parity storage. Data which is least utilized, such as the parity data and/or backup information of existing storage configurations, may be stored in the SATA drives. The SATA drives are generally less expensive and provide less reliability compared to the FC drives. In one example, additional redundancy may be implemented in a parity drive (e.g., the data P1-P5). A parity data P1-P5 may be used after a drive failure to reconstruct the original data back onto a replacement of the failed drive. Such additional redundancy may reduce the probability of drive failure in a customer scenario. The parity data may be written to the SATA drives, instead of the FC drive, if the RAID volume 106 comprises FC and SATA drives. However, the parity data may be written to either the SATA drives or the FC drives depending on the particular design criteria.

Referring to FIG. 8, a flow diagram of a process (or method) 200 is shown in accordance with the present invention. The process 200 generally comprises a step (or state) 202, a decision step (or state) 204, a step (or state) 206, a step (or state) 208, a step (or state) 210, a step (or state) 212, a step (or state) 214, a step (or state) 216, a decision step (or state) 218, a step (or state) 220, a step (or state) 222, a step (or state) 224 and a step (or state) 226. The method 200 may be implemented in the firmware 109 to distribute the data load across the FC, SAS and/or SATA drives. The combination FC, SAS and/or SATA drives may implement a hybrid drive volume 106.

The state 202 may represent a RAID volume creation state. The decision state 204 may determine the hybrid drive combination for the RAID volume 106. The state 206 may represent a FC and SATA drive volume combination. The state 208 may represent a FC and SAS drive volume combination. The state 210 may represent a SATA and SAS drive volume combination. The state 212 may represent a SAS, FC and SATA drive volume combination. In the state 214, data may be written onto/from the RAID volume 106 based on the frequency of data and/or data availability. In the state 216, data on the hybrid drive (e.g., the drive 106) may be moved between individual drives (e.g., the drives 120a-120n, 122a-122n and/or 124a-124n). For example, data that is more frequently accessed may be moved to a faster operating drive.

The decision state 218 may determine a data category for the data. In the state 218, if the RAID volume 106 comprises SAS and SATA drives and if data is critical (e.g., the highest accessed data), or if the data is used for high availability, then the data may be stored on a SAS drive in the state 220. If the data is less frequently accessed, then the data may be stored on a SATA drive in the state 224. In the state 218, if the RAID volume 106 comprises SAS and FC drives and if data is less frequently used, then the data may be stored on a SAS drive in the state 220. If the data is used for high availability, then the data may be stored on a FC drive in the state 222. In the state 218, if the RAID volume 106 comprises SAS, FC and SATA drives and if data is critical (e.g., frequently accessed data), then data may be stored on a SAS drive in the state 220. If the data is used for high availability, then the data may be stored on a FC drive in the state 222. If the data is less frequently accessed, then the data may be stored on a SATA drive in the state 224. In the state 226, meta data may be updated with the logical mapping of data in the RAID volume 106 with the physical mapping (e.g., tray ID, slot, etc.) of the backend drives.

The RAID volume 106 may comprise a combination of SAS, SATA and/or FC drives without affecting the input/output processing. The data written on the backend disks may be modified to meet certain design criteria, such as the frequently accessed data, highly available data and/or the data which needs to be backed up. The method 200 may be implemented to store the corresponding data on the respective drives 120a-120n, 122a-122n and/or 124a-124n depending on the type of drives involved in the RAID volume 106.

The functions performed by the diagram of FIG. 8 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (electronically programmable ROMs), EEPROMs (electronically erasable ROMs), UVPROM (ultra-violet erasable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, storage and/or playback devices, video recording, storage and/or playback devices, game platforms, peripherals and/or multi-chip modules. Those skilled in the relevant art(s) would understand that the elements of the invention may be implemented in other types of devices to meet the criteria of a particular application.

While the invention has been particularly shown and described with reference to the preferred embodiments thereof, it will be understood by those skilled in the art that various changes in form and details may be made without departing from the scope of the invention.

1. An apparatus comprising:
a controller configured to generate a control signal in response to one or more input/output requests; and
a plurality of storage drives arranged as one or more volumes, wherein (i) each of said volumes comprises a plurality of drive groups, (ii) each of said groups comprises a particular type of storage drive and (iii) said controller is configured to form said volume across drives from two or more of said groups.

2. The apparatus according to claim 1, wherein said controller further comprises:
a mapping table to categorize data associated with said storage drives.

3. The apparatus according to claim 1, wherein said volume comprises a Redundant Array of Independent Disks (RAID) volume made up of a combination of two or more of Serial Attached SCSI (SAS), Fibre Channel (FC) and/or Serial ATA (SATA) storage drives.

4. The apparatus according to claim 1, wherein said controller comprises firmware to categorize data associated with said storage drives.

5. The apparatus according to claim 4, wherein said firmware manages reading/writing of data to said storage drives.

6. The apparatus according to claim 4, wherein said firmware determines a particular drive type to store data.

7. The apparatus according to claim 1, wherein said volumes comprise a hybrid mixture of drives.

8. The apparatus according to claim 1, wherein writing/reading of data to/from said storage drives is based on frequency of said data and/or data availability.

9. An apparatus comprising:
means for generating a control signal in response to one or more input/output requests; and
means for arranging a plurality of storage drives arranged as one or more volumes, wherein (i) each of said volumes comprises a plurality of drive groups, (ii) each of said groups comprises a particular type of storage drive and (iii) said apparatus is configured to form said volume across drives from two or more of said groups.

10. A method of creating a RAID volume in a heterogenous mode, comprising the steps of:
generating a control signal in response to one or more input/output requests; and
arranging a plurality of storage drives arranged as one or more volumes, wherein (i) each of said volumes comprises a plurality of drive groups, (ii) each of said groups comprises a particular type of storage drive and (iii) said method is configured to form said volume across drives from two or more of said groups.

11. The method according to claim 10, further comprising the step of:
determining a hybrid combination of drives for said drive groups, wherein said hybrid combination of drives comprises a FC drive and a SATA drive.

12. The method according to claim 10, further comprising the step of:
determining a hybrid combination of drives for said drive groups, wherein said hybrid combination of drives comprises a FC drive and a SAS drive.

13. The method according to claim 10, further comprising the step of:
determining a hybrid combination of drives for said drive groups, wherein said hybrid combination of drives comprises a SATA drive and a SAS drive.

14. The method according to claim 10, further comprising the step of:
determining a hybrid combination of drives for said drive groups, wherein said hybrid combination of drives comprises two or more of a SAS drive, a FC drive, and a SAS drive.

15. The method according to claim 10, further comprising the step of:
determining a data category for data written/read onto/from said volumes based on frequency of data and data availability, wherein said data category comprises two or more of a SAS drive, a FC drive or a SATA drive.
